(19) United States
(12) Patent Application Publication
(10) Pub. No.: US 2011/0272376 A1
(43) Pub. Date: Nov. 10, 2011

(54) TROLLEY ASSEMBLY FOR A CRANE AND A CRANE THEREWITH

(75) Inventors: Yunsub JUNG, Daejeon (KR); In Gwun Jang, Daejeon (KR); Eun Ho Kim, Daejeon (KR); Hanjong Ju, Daejeon (KR); Kyung-Soo Kim, Daejeon (KR); Kyung Il Kim, Daejeon (KR); Byung Man Kwak, Daejeon (KR)

(73) Assignee: KOREA ADVANCED INSTITUTE OF SCIENCE AND TECHNOLOGY, Daejeon (KR)

(21) Appl. No.: 12/968,313

(22) Filed: Dec. 15, 2010

(30) Foreign Application Priority Data
May 10, 2010 (KR) 10-2010-0043419

(51) Int. Cl. B66C 13/18; B66C 13/22

(52) U.S. Cl. 212/276

(57) ABSTRACT

A crane for loading and unloading a cargo includes a trolley assembly. The trolley assembly includes a first trolley movable in a longitudinal direction along a boom of the crane; a second trolley movable in a lateral direction on the first trolley; a hoist provided on the second trolley; a spreader movable in a vertical direction by the hoist; a light emitting unit provided on the spreader; and a smart camera for capturing an image of the light emitting unit to measure a movement of the spreader. A movement of the hoist is controlled by a location control unit based on the measured movement of the spreader.

### FIELD OF THE INVENTION

The present invention relates to a trolley assembly and a crane for loading and unloading a cargo.

### BACKGROUND OF THE INVENTION

A marine transportation using ships as a goods movement means to a remote area consumes less energy compared with other transportation and incurs a low transportation cost, so it takes a large portion of global trade.

Recently, a marine transportation such as a container carrier uses a large ship in order to improve the efficiency of transportation, and the use of the large ship increases the volume of traffic of ships to secure economical efficiency of transportation. Thus, more harbors having mooring facilities for allowing a large ship to come alongside the pier and loading and unloading facilities are increasingly required.

However, harbors allowing a large container ship to come alongside the pier are limited around the world, and construction of such a harbor incurs much cost due to dredging or the like for maintaining the depth of water in the harbor and requires a spacious area. In addition, the construction of a big harbor causes traffic congestion nearby or greatly affects the surrounding environment such as damage to a coastal environment, leaving a variety of restrictions to the construction of a big harbor.

Thus, research into a mobile harbor allowing a large ship to anchor in the sea away from the land and to handle cargos, rather than making a large ship to come alongside the pier in the harbor, is under way.

FIG. 1 is a schematic view showing that a container C handling operation with respect to a container carrier S is performed by a crane 1 installed in a ship 50 serving as a mobile harbor. Here, a widthwise direction of a boom 10 (or a lengthwise direction of the ship 50) is defined as a lateral direction (X direction in the figure), and a lengthwise direction of the boom 10 (or a widthwise direction of the ship 50) is defined as a longitudinal direction (Y direction in the figure).

In general, the crane 1 includes a spreader 30 grasping the container C and moving in the vertical direction, a trolley 20 supporting the spreader 30 and moving in the longitudinal direction, and the boom 10 guiding the movement of the trolley 20. The spreader 30 moves in the vertical direction by using a hoist wire system.

Meanwhile, in the sea, the ship 50 and the spreader 30 are bound to be moved (or shaken or twisted) due to the influence of wind, wave, tidal current, and the like. The movement may typically include swaying, surging, and skewing. In this case, in the conventional crane 1, the trolley 20 moving along the boom 10 and the spreader 30 mounted on the trolley 20 can move only in the longitudinal direction.

Therefore, when a relative location between the spreader 30 and the container C to be loaded and unloaded fails to be maintained due to swaying or the like, there is a difficulty in fastening or separating them. When the spreader 30 is shaken or moved, it is difficult to measure movement of the spreader 30. And further, in order to correct location of the spreader, the crane 1 itself or the ship 50 itself must be necessarily moved, causing a problem in that controlling is not easy and much power is consumed.

### SUMMARY OF THE INVENTION

The present invention provides a trolley assembly for a crane capable of easily controlling and stabilizing the posture (or location) of a spreader by accurately measuring the movement of the spreader.

In accordance with an aspect of the present invention, there is provided a trolley assembly for a crane, comprising: a first trolley movable in a longitudinal direction along a boom of the crane; a second trolley movable in a lateral direction on the first trolley; a hoist provided on the second trolley; a spreader movable in a vertical direction by the hoist; a light emitting unit provided on the spreader; and a smart camera for capturing an image of the light emitting unit to measure a movement of the spreader, wherein a movement of the hoist is controlled by a location control unit based on the measured movement, of the spreader.

In accordance with another aspect of the present invention, there is provided a crane including the trolley assembly.

### BRIEF DESCRIPTION OF THE DRAWINGS

The objects and features of the present invention will become apparent from the following description of embodiments, given in conjunction with the accompanying drawings, in which:

FIG. 1 is a schematic view showing that a cargo handling operation with respect to a container carrier is performed by a crane installed in a ship;

FIG. 2 is a schematic view showing the structure of a trolley assembly used for a crane in accordance with an embodiment of the present invention;

FIG. 3 is a schematic view showing the light sources mounted in a spreader;

FIG. 4 is a schematic block diagram showing the configuration of a smart camera mounted in a trolley assembly;

FIG. 5 is a flowchart illustrating the process of a method for controlling the posture of a crane spreader in accordance with an embodiment of the present invention;

FIG. 6A shows the shape of a spreader viewed from the smart camera;

FIG. 6B shows an image obtained by binarizing an image captured by the smart camera;

FIG. 6C shows a state in which the respective clusters of the light source and noise are labeled;

FIG. 6D shows a state in which positions of the two light sources are detected;

FIG. 7A is a schematic view showing various states of the spreader, and

FIG. 7B is a schematic view showing the process of analyzing an image by the smart camera.

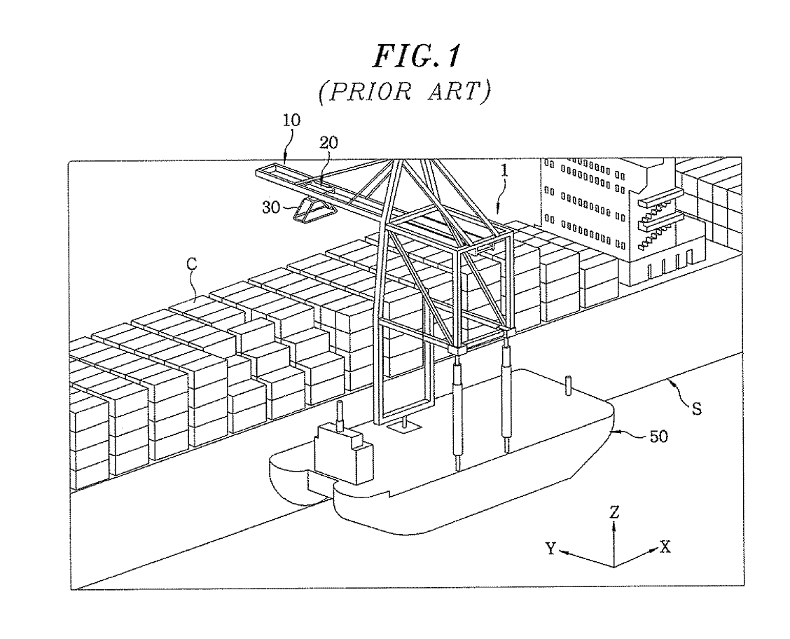

### DETAILED DESCRIPTION OF THE EMBODIMENTS

Hereinafter, embodiments of the present invention will now be described with reference to the accompanying drawings, in which the same reference numerals are used for the same or corresponding elements and repeated description therefor will be omitted.

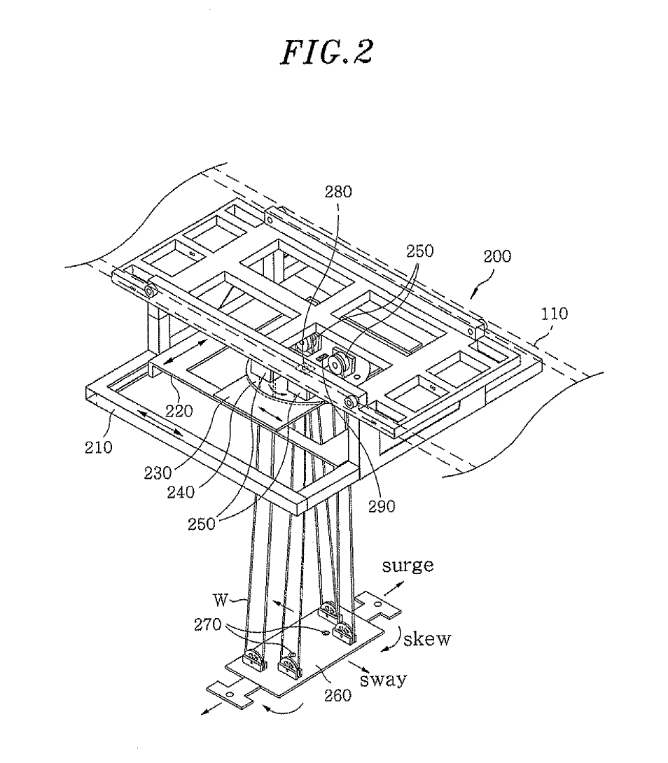

The structure and function of a trolley assembly in accordance with an embodiment of the present invention will now be described with reference to FIGS. 2 to 4.

FIG. 2 is a schematic view showing the structure of a trolley assembly used for a crane in accordance with an embodiment of the present invention.

As shown therein, a trolley assembly 200 includes a first trolley 210, a second trolley 220, a third trolley 230, a rotor 240, a hoist 250, a spreader 260, light sources 270, a smart camera 280, and a location control unit 290.

The first trolley 210 may move in a longitudinal direction along a boom 110 of a container crane. The first trolley 210 is largely used to be moved when a cargo such as a container is transferred.

The second trolley 220 may move in a lateral direction on the first trolley 210, and the third trolley 230 may move in a longitudinal direction on the second trolley 220. Alternatively, it may be configured such that the third trolley 230 moves on the first trolley 210 and the second trolley 220 moves on the third trolley 230.

The rotor 240 is rotatably connected on the first trolley 210. In the present embodiment, the rotor 240 is provided on the third trolley 230.

The hoist 250 is movable by two or more axes on the first trolley 210. In the present embodiment, the hoist 250 is provided on the rotor 240.

The spreader 260 is connected with the hoist 250 through the wires W so as to move in a vertical direction (or to ascend and descend). The spreader 260 is used to grasp the container to transfer for load or unload of the container.

The hoist 250 and the spreader 260 can be triaxially moved depending on a lateral directional movement of the second trolley 220, a longitudinal directional movement of the third trolley 230, and a rotational movement of the rotor 240. The hoist 250 may wind or unwind wires W.

Alternatively, the third trolley 230 may not be provided. In this embodiment, still the hoist 250 can be moved in the longitudinal direction depending on a movement of the first trolley 210.

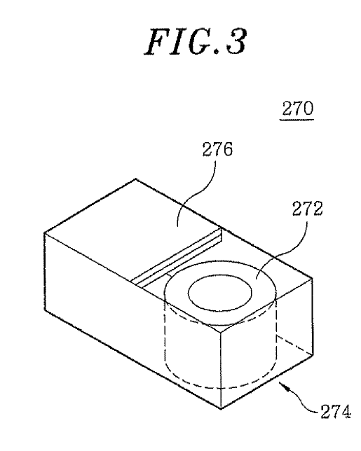

FIG. 3 is a schematic view showing the a light sources mounted in the spreader.

The light sources 270 are light emitting unit. The light sources 270 are provided on the spreader 260. The light source 270 may irradiate light having a wavelength of a particular band. In this embodiment, the light source 270 irradiates light of an infrared ray wavelength, and may irradiate, for example, light of an 850 nm band. Two or more light sources 270 may be provided. In this embodiment, two light sources 270 are provided at symmetrical locations.

The light source 270 includes a luminous body 272 irradiating light. The luminous body 272 may be an LED irradiating an infrared ray.

The light source 270 may include a housing 274 and a cover 276 protecting the luminous body. The housing 274 surrounds the luminous body 272 to reduce an impact applied from the exterior and protect the luminous body 272 against an external contaminant. The cover 276 is formed on an upper portion of the housing 274 to allow the luminous body to be selectively exposed to the exterior. In this embodiment, the cover 276 is configured to be open and closed, so that when the posture of the spreader 260 is required to be controlled, the cover 276 exposes the luminous body 272 and, at usual times, the cover 276 covers the luminous body 272 to protect it against the exterior.

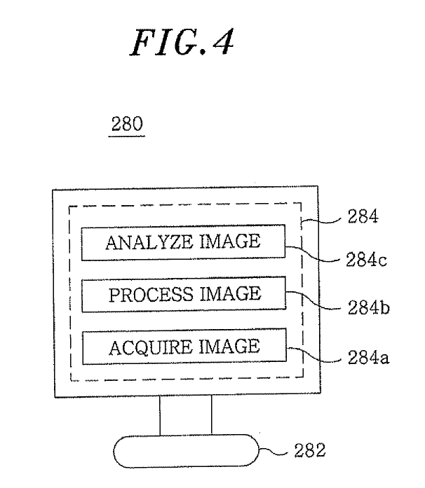

FIG. 4 illustrates a schematic block diagram of a smart camera mounted in a trolley assembly.

A smart camera 280 shown in FIG. 4 processes an image regarding the spreader 160 and the light sources 270 to measure the movement of the spreader 260. The smart camera 280 may be provided on the rotor 240, but is not limited thereto.

The smart camera 280 includes a filter lens 272 that allows light having a wavelength of a particular band irradiated by the light emitting unit, e.g, the light source 270 to selectively pass therethrough. In this embodiment, the filter lens 272 allows only light of an infrared ray band, e.g., light having a wavelength ranging from 840 nm to 860 nm, to pass therethrough.

The smart camera 280 includes a calculation module 284, e.g., a CPU, for processing an image. The calculation module 284 processes large capacity image information to calculate small capacity movement information, and transmits the calculated movement information to the location control unit 290.

The calculation module 284 can measure a current location of the spreader 260 with respect to a reference location. The calculation module 284 processes an image capturing (or including) two or more light sources 270 to measure a sway value, a surge value, and a skew value of the spreader 260. The calculation module 284 includes an image acquiring unit 284a for acquiring an image capturing the spreader 260 and the light sources 270, an image processing unit 284b for detecting positions of the light sources 270 based on the acquired image information, and an image analyzing unit 284c for calculating the movement of the spreader 260 based on the detected position information.

The location control unit 290 controls the movement of the hoist 250 based on the movement (e.g., shaking or twisting) information of the spreader 260 measured by using the light sources 270. Specifically, the location control unit 290 controls a longitudinal directional movement, a lateral directional movement, and a rotational movement of the hoist 250 on the basis of a sway value, a surge value, and a skew value, respectively. The location control unit 290 controls the location and posture of the spreader 260, as well as the location of the hoist 250, by moving the second trolley 220, the third trolley 230, and the rotor 240. In this embodiment, the location control unit 290 is provided on the trolley assembly 200. Alternatively, the location control unit 290 may be remote from the trolley assembly 200.

In this embodiment, unlike the measurement by general vision, the movement of the spreader 260 can be easily and accurately measured by minimizing the influence of environmental variables such as weather, brightness, and the like, and a damage or contamination of measurement-subject indexes, by using the light sources 270 which irradiates light having a wavelength of a particular band and the filter lens 282 which allows the light to pass through. Also, because the spreader 260 can be multi-axially moved owing to the multi-stage trolley structure and the location control unit 290 integrally controls them in real time, the location and posture of the spreader 260 can be easily controlled.

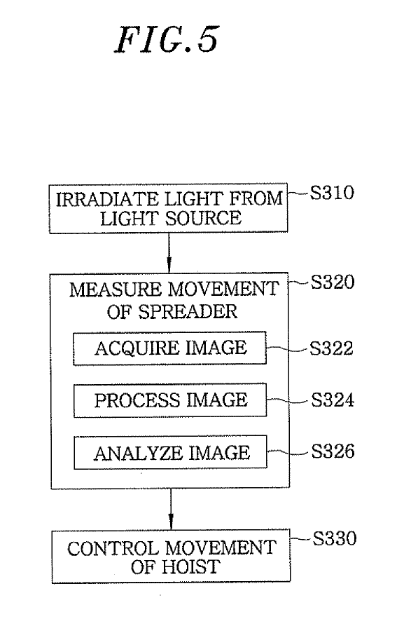

The method for controlling the posture of the spreader in accordance with an embodiment of the present invention will now be described with reference to FIGS. 5 to 7.

FIG. 5 is a flowchart illustrating the process of a method for controlling the posture of a crane spreader in accordance with an embodiment of the present invention.

The method for controlling the posture of the spreader includes irradiating light from a light source 270 prepared on the spreader 260 ascending or descending by the hoist 250 movable in the trolley assembly 200 (step S310), processing an image capturing (or including) the spreader 260 and the light source 270 by the smart camera 280 provided on the trolley assembly to measure the movement of the spreader 260 (step S320), and controlling the movement of the hoist 250 based on the measured movement information of the spreader 260 (step S330).

In step S310 of irradiating light, light is irradiated from two or more light sources 270. The two light sources may be provided to be symmetrical. The light sources 270 may irradiate light having a wavelength of a particular band.

In this embodiment, the wavelength of the particular band is an infrared ray wavelength.

Step S320 of measuring the movement includes capturing an image of the spreader 260 and the light source 270 (step S322), processing the image by detecting an position of the light source 270 based on the captured image information (step S324), and analyzing the image by calculating the movement of the spreader 260 based on the detected position information (step S326). Step S320 of measuring the movement is performed by the calculation module 284 of the smart camera.

In the image acquiring step S322, an image is captured by using the filter lens 282 that allows light having a wavelength of a particular band irradiated by the light source 270 to selectively pass therethrough. In this embodiment, the filter lens 282 allows only light of an infrared ray band to pass therethrough.

In the image processing step S324, the captured image information is binarized on the basis of a threshold value, labeled such that a label value is given to each cluster of the binarized image, and noise is canceled on the basis of a pixel size of each of the labeled clusters.

In the image analyzing step S326, the position and the movement of the spreader 260 can be measured. The movement of the spreader 260 is obtained by calculating the middle point and a rotation angle of the position of the two or more light sources 270. A sway value, a surge value, and a skew value of the spreader 260 are obtained by calculating a current location of the spreader 260 with respect to the reference location from the detected illumination area information.

The movement, controlling step S330 is performed by the location control unit 290. The movement of two or more axes of the hoist 250 is controlled based on the measured movement information of the spreader 260. In this embodiment, three axes of the longitudinal directional movement, the lateral directional movement, and the rotational movement of the hoist 250 are controlled by using the sway value, the surge value, and the skew value. The location and the posture of the spreader 260, as well as the location of the hoist 250, are controlled by moving the second trolley 220, the third trolley 230, and the rotor 240.

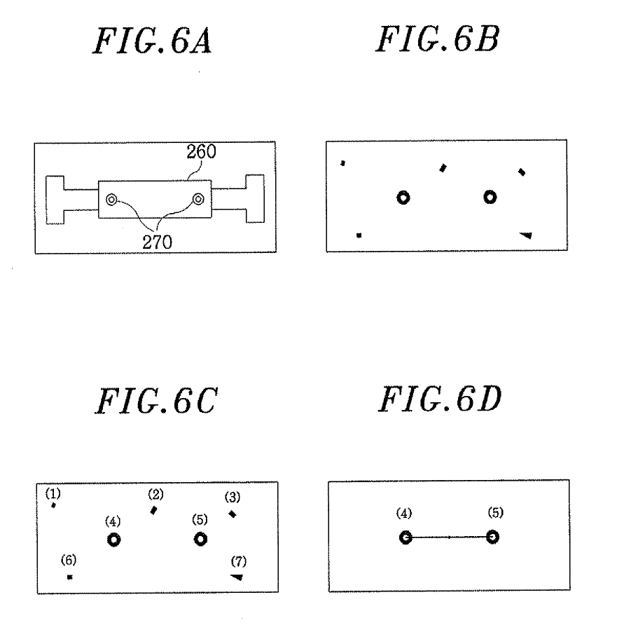

The image processing step S324 of the movement measurement step S320 will now be described in more detail with reference to FIGS. 6A-6D. FIGS. 6A-6D are schematically show the procedure of processing an image by the smart camera.

FIG. 6A shows the shape of an actual spreader viewed from the smart camera. The image captured by using the infrared filter lens 282 of smart camera includes two light sources 270 on the spreader 260 and noise components.

FIG. 6B shows an image obtained by binarizing the captured image information based on the threshold value. The pixel values of the infrared ray light source and the noise components are processed as 0 and pixel values of the other areas are processed as 255.

FIG. 6C shows a state in which the respective clusters of the light source and noise are labeled with the same designated label value. The clusters are inspected by sequentially checking pixel values to the entire area of the image. The respective clusters are designated (1) to (n) label values. In this embodiment, as illustrated, (1) to (7) label values are designated for the respective clusters.

FIG. 6D shows a state in which positions of the two light sources are detected without noise. Pixel sizes for the respective labels are checked, and when a label does not satisfy a certain reference size, it is determined to be noise and canceled. In this case, the reference size may be determined with reference to the difference between the light source (or the spreader) and the lens (or the smart camera). In this embodiment, the other remaining parts, excluding the labels (4) and (5) by the light sources, have been removed.

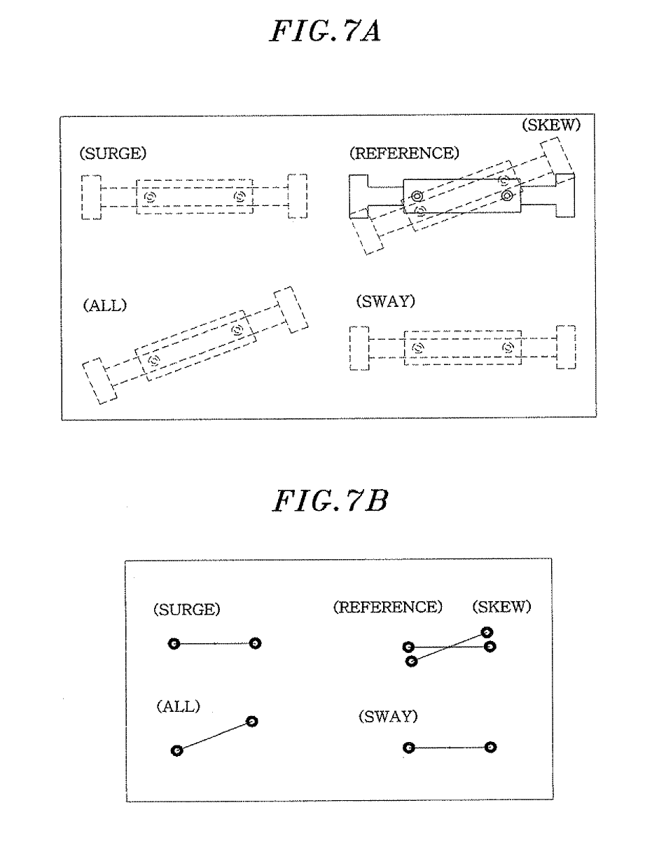

The image analyzing step S326 of the movement measurement step will now be described in more detail with reference to FIGS. 7A and 7B. FIG. 7A is a schematic view showing various states of the spreader. FIG. 7B is a schematic view showing the process of analyzing an image by the smart camera.

In FIG. 7A, (REFERENCE) shows the location of the light sources and the spreader when the spreader does not move, and this location of the spreader is a spreader reference location. (SWAY) shows a current location of the spreader when sway happens. (SURGE) shows a current location of the spreader when surge happens. (SKEW) shows a current location of the spreader when skew happens. (ALL) shows a current location of the spreader in which, sway, surge, and skew happen altogether. The movement of the spreader is measured by comparing the current locations of the two light sources which have been image-processed with the reference location.

In FIG. 7B, (REFERENCE) shows a state in which the spreader, which does not move, is image-processed by the smart camera. (SWAY) shows a state in which the spreader is image-processed when sway happens. (SURGE) shows a state in which the spreader is image-processed when surge happens. (SKEW) shows a state in which the spreader is image-processed when skew happens. (ALL) shows a state in which the spreader is image-processed a case in which, sway, surge, and skew happen altogether. By obtaining the center of each of the two light sources at the locations of (REFERENCE) to (ALL), the middle point between the two light sources can be calculated and a rotation angle of a segment of a line connecting the two light sources can be also calculated.

The sway value, the surge value, and the skew value can be calculated by comparing the current location, e.g., the middle point and the rotation angle calculated at the location (ALL), with the reference location, i.e., the middle point and the rotation angle at the location (REFERENCE). In this case, the sway value and the surge value are obtained with reference to the distance between the light sources (or the spreader) and the lens (or the camera).

In this embodiment, because the smart camera 280 which can process information by itself is used, a separate calculation processing device and a large capacity data transmission process can be omitted, whereby an image can be quickly processed and a measurement-related device can be simply implemented. Also, the location can be accurately controlled by using an algorithm that simply and effectively calculates the movement of two or more axes by using the two light sources 270.

A trolley assembly 200 in accordance with an embodiment of the present invention may be provided in a crane. The trolley assembly 200 can be moved in a longitudinal direction along a boom 110 of the crane. The crane may be installed in a floating body floating in the sea or in a mobile harbor to load and unload a container.

The floating body may be a ship which can be movable with self-power or a floating structure moored to the sea. The floating body, floating on the sea, may serve as a mobile harbor for delivering a container to the container carrier or temporarily loading the container, instead of a harbor of the land or in addition to the harbor of the land.

The floating body, which is a mobile harbor, may include a platform having a space in which the container is loaded, a location determining device for acquiring information regarding the location of the platform, a mooring device for maintaining a connected state without colliding with the container carrier while a container is loaded or unloaded, and a balancing device for adjusting the platform such that the platform can be maintained in a vertical location correspondingly to a change in the weight based on the loading and unloading of the container.

In accordance with the embodiment of the present invention, because the posture of the spreader can be easily controlled and stabilized by accurately measuring the movement of the spreader in handling a container, the loading and unloading of the container can be smoothly performed although the mobile harbor and the spreader are moved or shaken.

While the invention has been shown and described with respect to the preferred embodiments, it will be understood by those skilled in the art that various changes and modifications may be made without departing from the scope of the invention as defined in the following claims.

What is claimed is:

1. A trolley assembly for a crane, comprising:
a first trolley movable in a longitudinal direction along a boom of the crane;
a second trolley movable in a lateral direction on the first trolley;
a hoist provided on the second trolley;
a spreader movable in a vertical direction by the hoist;
a light emitting unit provided on the spreader; and
a smart camera for capturing an image of the light emitting unit to measure a movement of the spreader,
wherein a movement of the hoist is controlled by a location control unit based on the measured movement of the spreader.

2. The trolley assembly of claim 1, further comprising a third trolley movable in a longitudinal direction on the second trolley.

3. The trolley assembly of claim 1, further comprising a rotor rotatably provided on the second trolley.

4. The trolley assembly of claim 3, wherein the smart camera is configured to process the captured image to calculate a current location of the spreader with respect to a reference location, and
the location control unit is configured to control a longitudinal movement, a lateral movement, and a rotational movement of the hoist based on the current location.

5. The trolley assembly of claim 1, wherein the light emitting unit includes two or more light sources, and
the smart camera is configured to process the captured image of the two or more light sources to calculate a sway value, a surge value, and a skew value of the spreader.

6. The trolley assembly of claim 5, wherein the number of the light sources is two, and the two light sources are provided to be symmetrical with respect to the center of the spreader.

7. The trolley assembly of claim 5, wherein each of the light sources includes a luminous body for irradiating a light, a housing surrounding the luminous body to protect it, and a cover formed on the housing to allow the luminous body to be selectively exposed.

8. The trolley assembly of claim 1, wherein the light emitting unit irradiates a light having a wavelength of a particular band, and
the smart camera includes a filter lens allowing the light to selectively pass therethrough.

9. The trolley assembly of claim 8, wherein the smart camera includes:
an image acquiring unit for acquiring an image of the light source;
an image processing unit for detecting a position of the light emitting unit based on the acquired image; and
an image analyzing unit for calculating the movement of the spreader based on the detected position.

10. A crane comprising the trolley assembly of claim 1.

11. The crane of claim 10, the trolley assembly further comprising a third trolley movable in a longitudinal direction on the second trolley.

12. The crane of claim 10, the trolley assembly further comprising a rotor rotatably provided on the second trolley.

13. The crane of one of claim 12, wherein the smart camera is configured to process the captured image to calculate a current location of the spreader with respect to a reference location, and
the location control unit is configured to control a longitudinal movement, a lateral movement, and a rotational movement of the hoist based on the current location.

14. The crane of one of claim 10, wherein the light emitting unit includes two or more light sources, and
the smart camera is configured to process the captured image of the two or more light sources to calculate a sway value, a surge value, and a skew value of the spreader.

15. The trolley assembly of claim 10, wherein the light emitting unit irradiates a light having a wavelength of a particular band,
the smart camera includes a filter lens allowing the light to selectively pass therethrough.

16. The trolley assembly of claim 15, wherein the smart camera includes:
an image acquiring unit for acquiring an image of the light source;
an image processing unit for detecting a position of the light emitting unit based on the acquired image; and
an image analyzing unit for calculating the movement of the spreader based on the detected position.

17. The crane of claim 10, the trolley assembly further comprising:
a third trolley movable in a longitudinal direction on the second trolley,
a rotor rotatably provided on the second trolley.

18. The crane of claim 17, wherein the light emitting unit includes two or more light sources,
the smart camera is configured to process the captured image of the two or more light sources to calculate a current location of the spreader with respect to a reference location to calculate a sway value, a surge value, and a skew value of the spreader, and
the location control unit is configured to control a longitudinal movement, a lateral movement, and a rotational movement of the hoist based on the values.
